(19) United States
(12) Patent Application Publication
(10) Pub. No.: US 2007/0065796 A1
(43) Pub. Date: Mar. 22, 2007

(54) Optical module for recognizing page of electronic book

(76) Inventors: Li-Hung Lai, Taichuang (TW); Wen-Sheng Hsieh, Taichuang (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/228,302

(22) Filed: Sep. 19, 2005

(51) Int. Cl. G09B 5/00

(52) U.S. Cl. 434/317

(57) ABSTRACT

The invention relates to an optical module for recognizing the pages of an electronic book. The optical module of the invention comprises: at least one light source, a plurality of reflective layers, at least one light sensor and a page recognizing device. The light source is used for generating emitting light and is mounted on a cover of the electronic book. The reflective layers are used for reflecting the emitting light, and each reflective layer is mounted on one of pages of the electronic book. The light sensor is used for receiving the reflective light from the reflective layers and outputting a corresponding signal. The page recognizing device is used for recognizing a current page of the electronic book according to the corresponding signal. According to the invention, the different reflective area on the different reflective layer is used to reflect the different reflective light, so the electronic book can recognize the page which the user currently opens. Because the reflective area can be precisely controlled to reflect the exact reflective light, the page recognizing device can precisely recognize the current page.

### BACKGROUND OF THE INVENTION

1. Field of the Invention

The present invention relates to an optical module, more particularly, an optical module for recognizing the pages of an electronic book.

2. Description of the Related Art

Referring to FIG. 6, a conventional electronic book 60 comprises: a cover 61, a plurality of pages 62, 63, 64, a weighing sensor 65 and a page recognizing device 66. The weighing sensor 65 is mounted on the cover 61 of the electronic book 60, and is used to calculate the total weight of the pages on the weighing sensor 65. From the total weight of the pages, the page recognizing device 66 can recognize the page which the user currently opens. Therefore, the electronic book 60 can access and output the corresponding data from the memory according to the current page.

Nevertheless, because the weight of each page is light, the weighing sensor 65 must be accurate so as to precisely calculate the total weight of the pages. Therefore, the cost of the weighing sensor 65 must be expensive. Furthermore, if the user's hand touches the page or something is disposed on the page, the total weight calculated by the weighing sensor 65 may be wrong. The electronic book 60 may access and output the wrong corresponding data.

Therefore, it is necessary to provide an optical module for recognizing the pages of an electronic book so as to solve the above problem.

### SUMMARY OF THE INVENTION

One objective of the present invention is to provide an optical module for recognizing the pages of an electronic book. The optical module of the invention comprises: at least one light source, a plurality of reflective layers, at least one light sensor, at least one filter, at least one shielding layer and a page recognizing device. The light source is used for generating emitting light and mounted on a cover of the electronic book. The reflective layers are used for reflecting the emitting light, and each reflective layer is mounted on one of pages of the electronic book. The light sensor is used for receiving the reflective light from the reflective layers and outputting a corresponding signal. The filter is used for filtering surrounding light. The shielding layer is disposed between the light source and the light sensor, and is used for shielding the emitting light from the light source into the light sensor. The page recognizing device is used for recognizing a current page of the electronic book according to the corresponding signal.

According to the invention, the different reflective area on the different reflective layer is used to reflect the different reflective light, so the electronic book can recognize the page which the user currently opens. Because the reflective area can be precisely controlled to reflect the exact reflective light, the page recognizing device can precisely recognize the current page so as to solve the problem in the conventional electronic book.

### BRIEF DESCRIPTION OF THE DRAWINGS

FIG. 1 shows an electronic book having an optical module for recognizing a current page (a second page), according to a first embodiment of the invention.

FIG. 2 shows the electronic book having the optical module for recognizing a current page (a third page), according to the first embodiment of the invention.

FIG. 3A shows a first page having a first reflective layer, according to the first embodiment of the invention.

FIG. 3B shows a second page having a second reflective layer, according to the first embodiment of the invention.

FIG. 3C shows a third page having a third reflective layer, according to the first embodiment of the invention.

FIG. 4 shows an electronic book having an optical module for recognizing a current page (a third page), according to a second embodiment of the invention.

FIG. 5A shows a first page having a first reflective layer and a second reflective layer, according to the second embodiment of the invention.

FIG. 5B shows a second page having a third reflective layer and a fourth reflective layer, according to the second embodiment of the invention.

FIG. 6 shows a convention electronic book having a weighting sensor for recognizing a current page.

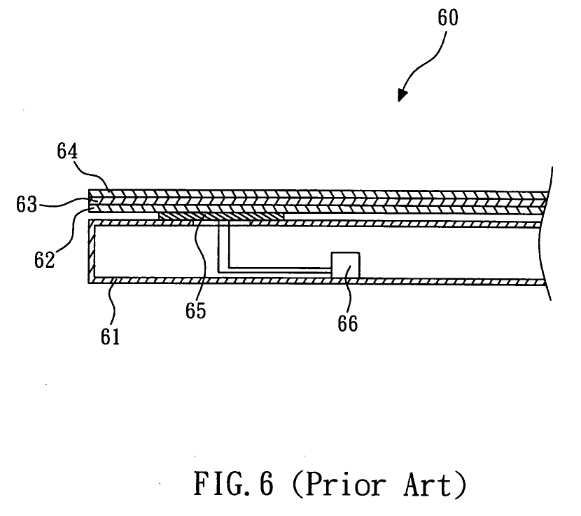

### DETAILED DESCRIPTION OF THE INVENTION

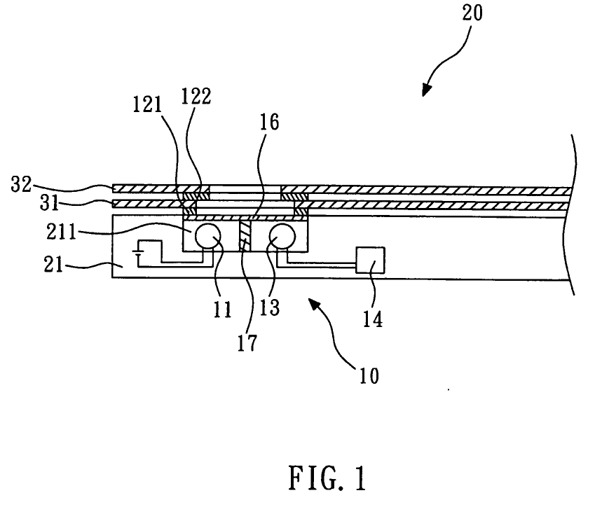

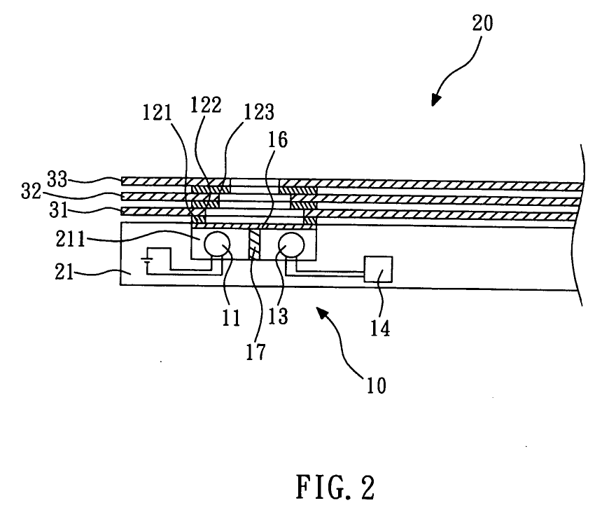

Referring to FIG. 1 and FIG. 2, they show an optical module for recognizing the pages of an electronic book, according to a first embodiment of the invention. The optical module 10 comprises: a light source 11, a plurality of reflective layers 121, 122, 123, a light sensor 13, a page recognizing device 14, a filter 16 and a shielding layer 17. The light source 11 is used for generating emitting light and mounted on a cover 21 of the electronic book 20. Preferably, the emitting light is infrared light, and the light source may be a laser diode or a light emitting diode (LED). The cover 21 of the electronic book 20 comprises a slot 211 for containing the light source 11 and the light sensor 13.

The reflective layers 121, 122, 123 are used for reflecting the emitting light, and each reflective layer is mounted on one of the pages of the electronic book 20. For example, the first reflective layer 121 is mounted on a first page 31 of the electronic book 20; the second reflective layer 122 is mounted on a second page 32 of the electronic book 20; and the third reflective layer 123 is mounted on a third page 33 of the electronic book 20. The reflective layers 121, 122, 123 may be metal layers or reflective films.

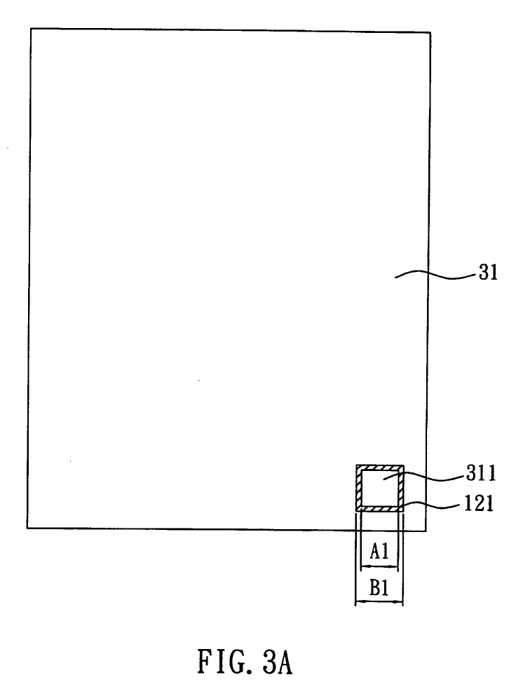

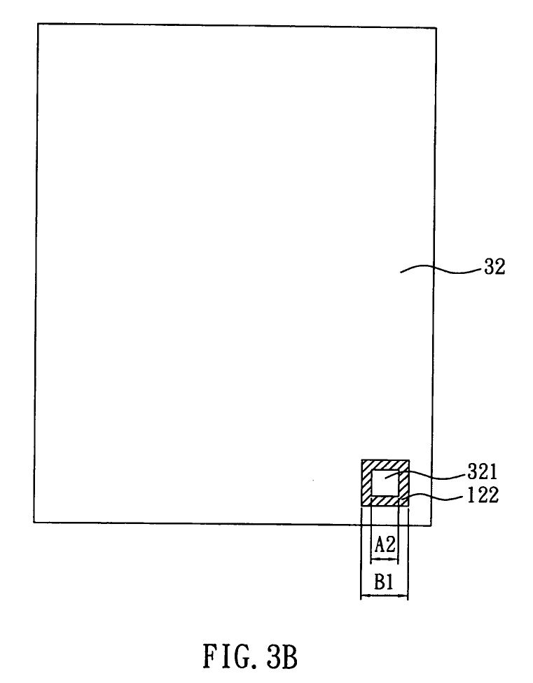

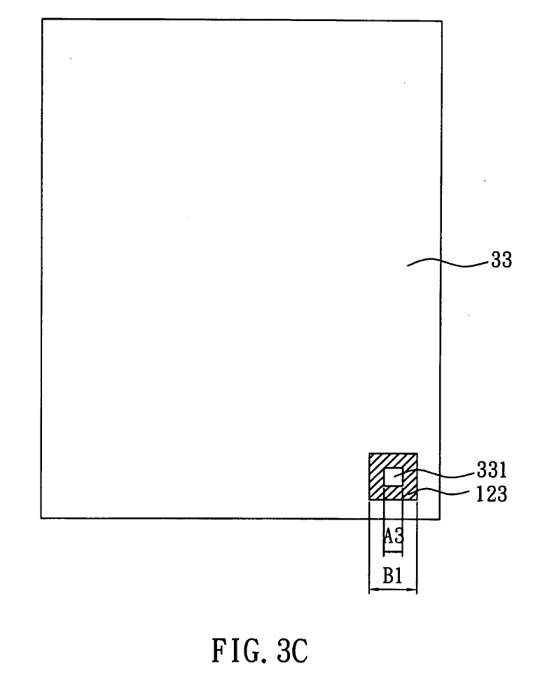

Referring to FIGS. 3A to 3C, they show the pages of the electronic book. The pages of the electronic book 20 each comprise an aperture. Referring to FIG. 3A, the first page 31 has an aperture 311. The aperture 311 is a square shape. The first reflective layer 121 is mounted on the periphery of the aperture 311, and the first reflective layer 121 is formed as an enclosed shape. An outer diameter of the first reflective layer 121 is B1, and an inner diameter of the first reflective layer 121 is A1.

Referring to FIG. 3B, the second page 32 has an aperture 321. The aperture 321 is also a square shape. The second reflective layer 122 is mounted on the periphery of the aperture 321, and the second reflective layer 122 is formed as an enclosed shape. An outer diameter of the second reflective layer 122 is B1, and an inner diameter of the second reflective layer 122 is A2. Wherein, the size of the inner diameter A2 of the second reflective layer 122 is smaller than that of the inner diameter A1 of the first reflective layer 121. That is, the size of the aperture 321 is smaller than that of the aperture 311. Besides, because the second page 32 must be disposed on the first page 31, the outer diameter of the second reflective layer 122 may be A1 the same as the inner diameter of the first reflective layer 121 in FIG. 3A.

Referring to FIG. 3C, the third page 33 has an aperture 331. The aperture 331 is also a square shape. The third reflective layer 123 is mounted on the periphery of the aperture 331, and the third reflective layer 123 is formed as an enclosed shape. An outer diameter of the third reflective layer 123 is B1, and an inner diameter of the third reflective layer 123 is A3. The size of the inner diameter A3 of the third reflective layer 123 is smaller than that of the inner diameter A2 of the second reflective layer 122. In other words, the size of the aperture 331 is smaller than that of the aperture 321. Given the above, the sizes of the apertures of pages decrease gradually from the first page 31 to the last page of the electronic book, and the first page 31 is adjacent to the light source 11. The last page may have no aperture, but the last reflective layer must still be mounted on the last page to reflect the emitting light. Furthermore, the apertures of the pages may be a circular, diamond or any predetermined shape.

Referring to FIG. 1 again, the light sensor 13 is used for receiving the reflective light from the reflective layers and outputting a corresponding signal. When the second page 32 is opened to be disposed on the first page 31, part of the second reflective layer 122 is exposed to reflect more emitting light than the first reflective 121. Referring to FIG. 2, when the third page 33 is opened to dispose on the second page 32, part of the third reflective layer 123 is exposed to reflect more emitting light than the second reflective layer 122. Therefore, the light sensor 13 can receive the different reflective light from the reflective layers above the light sensor 13, and output the corresponding signal according to the reflective light.

The filter 16 is disposed above the light source 11 and the light sensor 13, and is used for filtering the surrounding visible light. The shielding layer 17 is disposed between the light source 11 and the light sensor 13, and is used for shielding the emitting light from the light source 11 and for preventing the emitting light from entering into the light sensor 13. According to the corresponding signal from the light sensor 13, the page recognizing device 14 can recognize a current page of the electronic book 20. The electronic book 20 can access and output the corresponding data from the memory according to the current page.

According to the first embodiment of the invention, the different reflective area on the different reflective layer is used to reflect the different reflective light, so the electronic book can recognize the page which the user currently opens. Because the reflective area can be precisely controlled to reflect the exact reflective emitting light, the page recognizing device can precisely recognize the current page so as to solve the problem of the wrong total weight of the pages in the conventional electronic book.

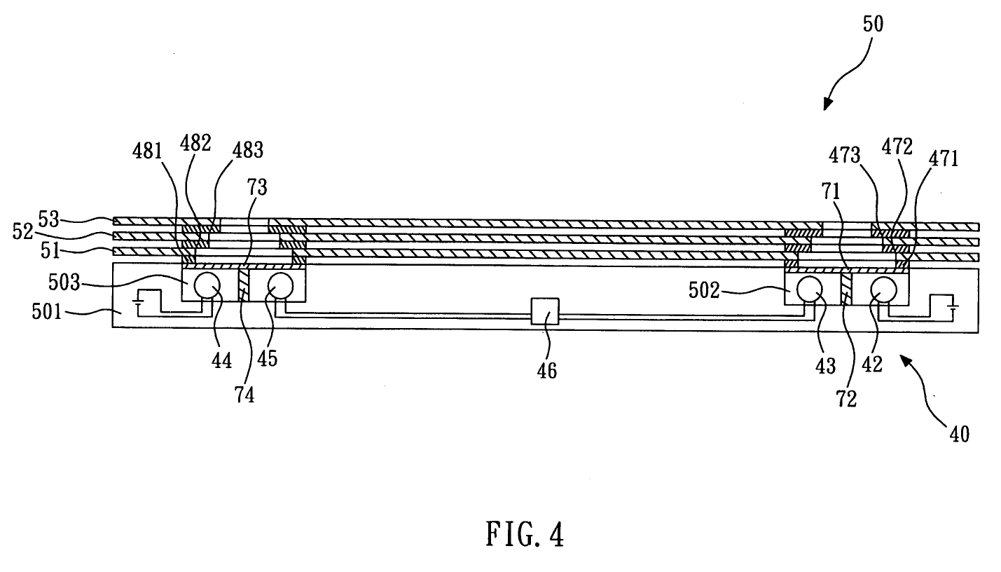

Referring to FIG. 4, it shows an optical module for recognizing the pages of an electronic book, according to a second embodiment of the invention. The optical module 40 comprises: two light sources 42, 44, a plurality of reflective layers 471, 472, 473, 481, 482, 483, two light sensors 43, 45, a page recognizing device 46, two filters 71, 73 and two shielding layers 72, 74. The light sources 42, 44 are used for generating emitting light and mounted on a cover 501 of the electronic book 50. Preferably, The emitting light is infrared light. The cover 501 of the electronic book 50 comprises a first slot 502 and a second slot 503, the first slot 502 is used for containing a first light source 42 and a first light sensor 43, the second slot 502 is used for containing a second light source 44 and a second light sensor 45.

The reflective layers 471, 472, 473 are used for reflecting the emitting light from the first light source 42, and the reflective layers 481, 482, 483 are used for reflecting the emitting light from the second light source 44. The reflective layers are mounted on the pages of the electronic book 50. For example, the first reflective layer 471 and the second reflective layer 481 are mounted on a first page 51 of the electronic book 50; the third reflective layer 472 and the fourth reflective layer 482 are mounted on a second page 52 of the electronic book 50; and the fifth reflective layer 473 and the sixth reflective layer 483 are mounted on a third page 53 of the electronic book 50.

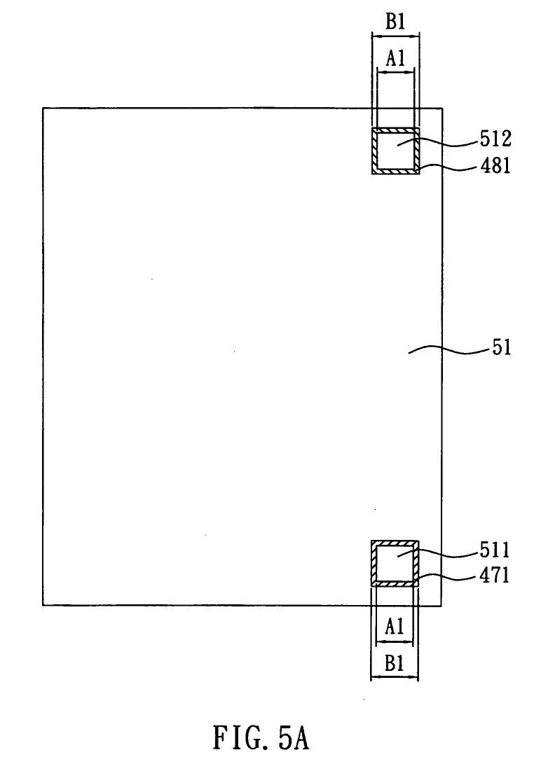

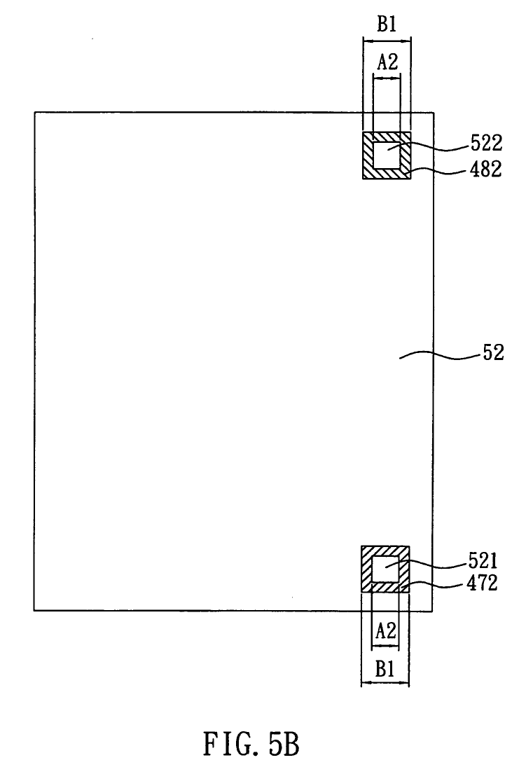

Referring to FIGS. 5A to 5B, they show the pages of the electronic book. The pages of the electronic book 50 each comprise two apertures. Referring to FIG. 5A, the first page 51 has a first aperture 511 and a second aperture 512. The apertures 511, 512 are square shapes. The first aperture 511 is corresponding to the first slot 502, and the second aperture 512 is corresponding to the second slot 503 as shown in FIG. 4. The first reflective layer 471 is mounted on the periphery of the first aperture 511, and the second reflective layer 481 is mounted on the periphery of the second aperture 512. The size and shape of the first reflective layer 471 and the second reflective layer 481 are the same as those of the first reflective layer 121 in FIG. 3A.

Referring to FIG. 5B, the second page 52 has a first aperture 521 and a second aperture 522. The apertures 521, 522 are square shapes. The third reflective layer 472 is mounted on the periphery of the first aperture 521, and the fourth reflective layer 482 is mounted on the periphery of the second aperture 522. The size and shape of the third reflective layer 472 and the fourth reflective layer 482 are the same as those of the second reflective layer 122 in FIG. 3B.

Referring to FIG. 4 again, the first light sensor 43 is used for receiving the reflective light from the reflective layers 471, 472, 473 and outputting a first corresponding signal; the second light sensor 45 is used for receiving the reflective light from the reflective layers 481, 482, 483 and outputting a second corresponding signal. In the second embodiment, there are two light sensors 43, 45 for double checking the reflective light so as to avoid the error by disposing something that can to reflect the emitting light on the current page.

The first filter 71 is disposed above the first light source 42 and the first light sensor 43, and is used for filtering the surrounding visible light. The first shielding layer 72 is disposed between the first light source 42 and the first light sensor 43, and is used for shielding the emitting light from the first light source 42 and for preventing the emitting light from entering into the first light sensor 43. The second filter 73 is disposed above the second light source 44 and the second light sensor 45, and is used for filtering the surrounding visible light. The second shielding layer 74 is disposed between the second light source 44 and the second light sensor 45, and is used for shielding the emitting light from the second light source 44 and for preventing the emitting light from entering into the second light sensor 45.

According to the first corresponding signal from the first light sensor 43 and the second corresponding signal from the second light sensor 45, the page recognizing device 46 can exactly recognize a current page of the electronic book 50. The electronic book 50 can access and output the corresponding data from the memory according to the current page.

According to the second embodiment of the invention, the first light source 42, the reflective layers 471, 472, 473, the first light sensor 43, the first filter 71 and the first shielding layer 72 are assembled to form a first set to obtain the first corresponding signal, and the second light source 44, the reflective layers 481, 482, 483, the second light sensor 45, the second filter 73 and the second shielding layer 74 are assembled to form a second set to obtain the second corresponding signal. Therefore, including the above advantage of the optical module 10 of the first embodiment, the optical module 40 can more precisely recognize the page which the user currently opens so as to avoid the error of the reflective light.

While an embodiment of the present invention has been illustrated and described, various modifications and improvements can be made by those skilled in the art. The embodiment of the present invention is therefore described in an illustrative, but not restrictive, sense. It is intended that the present invention may not be limited to the particular forms as illustrated, and that all modifications which maintain the spirit and scope of the present invention are within the scope as defined in the appended claims.

What is claimed is:

1. An optical module for recognizing the pages of an electronic book, comprising:
at least one light source, for generating emitting light and mounted on a cover of the electronic book;
a plurality of reflective layers, for reflecting the emitting light, each reflective layer mounted on one of the pages of the electronic book;
at least one light sensor, for receiving the reflective light from the reflective layers and outputting a corresponding signal;
at least one filter, for filtering surrounding light;
at least one shielding layer, disposed between the light source and the light sensor, for shielding the emitting light from the light source into the light sensor; and
a page recognizing device, for recognizing a current page of the electronic book according to the corresponding signal.

2. The optical module according to claim 1, wherein the emitting light is infrared light.

3. The optical module according to claim 1, wherein the reflective layers are metal layers.

4. The optical module according to claim 1, wherein the pages of the electronic book each comprise at least one aperture, and the reflective layer is mounted on the periphery of the aperture.

5. The optical module according to claim 4, wherein the reflective layer is formed as an enclosed shape.

6. The optical module according to claim 4, wherein the sizes of the apertures of pages decrease gradually from a first page to the last page of the electronic book, and the first page is adjacent to the light source.

7. The optical module according to claim 1, wherein the cover of the electronic book comprises at least one slot for containing the light source and the light sensor.

8. The optical module according to claim 7, wherein the cover of the electronic book comprises a first slot and a second slot, the first slot is used for containing a first light source and a first light sensor, and the second slot is used for containing a second light source and a second light sensor.

9. The optical module according to claim 8, wherein the pages of the electronic book each comprise a first aperture and a second aperture, and the first aperture is corresponding to the first slot and the second aperture is corresponding to the second slot.

10. The optical module according to claim 1, wherein the filter is disposed above the light source and the light sensor and is used for filtering the surrounding visible light.

11. The optical module according to claim 1, wherein the light source is a laser diode.
